(19) United States
(12) Patent Application Publication
(10) Pub. No.: US 2011/0280494 A1
(43) Pub. Date: Nov. 17, 2011

(54) METHOD AND APPARATUS FOR GENERATING ENHANCED IMAGES

(75) Inventors: Jorge Andreas Maria Da Rocha Leitao, 's-Hertogenbosch (NL); Gerard De Haan, Eindhoven (NL)

(73) Assignee: KONINKLIJKE PHILIPS ELECTRONICS N.V., EINDHOVEN (NL)

(21) Appl. No.: 13/144,498

(22) PCT Filed: Jan. 12, 2010
(86) PCT No.: PCT/IB2010/050097

§ 371 Date: Jul. 14, 2011

(30) Foreign Application Priority Data
Jan. 20, 2009 (EP) 09150908.3

(51) Int. Cl. G06K 9/40

(52) U.S. Cl. 382/274

(57) ABSTRACT

A method and apparatus for generating an enhanced image is provided. The method includes receiving (101) an image to be enhanced. A set of sub images is generated (103) from the image where the different sub images correspond to different spatial frequency bands for the image. A pixel value variation is determined (107) in a neighborhood region of the first pixel region for at least a first pixel region of the image. An enhanced pixel region is then generated (109) for the enhanced image by combining the first pixel region and corresponding pixel regions of sub images in response to the pixel value variation. Specifically, a weighted summation of the input image and sub images may be generated with the weights being determined in response to the luminance variance in the neighborhood region. The invention may e.g. provide improved contrast enhancement with reduced artifacts and/or noise.

### FIELD OF THE INVENTION

The invention relates to image enhancement and in particular, but not exclusively, to contrast enhancement of e.g. digital pictures or frames of a digital video signal.

### BACKGROUND OF THE INVENTION

Contrast enhancement of images has become increasingly important and feasible in recent years. Specifically, digital images, such as frames of a video signal or photos, can be processed by advanced signal processing techniques in order to generate enhanced images with improved contrast thereby typically resulting in the images being perceived to be of higher quality.

Contrast enhancement of images typically involves analysis and modification of the histogram of the luminance values. A convenient way of implementing such a contrast enhancement algorithm is by applying a (non-)linear transfer function to the grey levels of the video signal. For example, power-law transformations such as the well known gamma correction are wide-spread. Adaptive methods, such as histogram equalization, may be applied to determine the shape of the non-linear transfer function relating the input luminance of a pixel to the output luminance. Histogram equalization has been successfully applied in many fields, such as medical imaging and remote sensing. Its ability to optimally distribute signal variations over the available luminance levels is particularly appealing for images where feature identification is the dominant aim. Application of histogram equalization to natural images, however, often results in sub-optimal and over-enhanced signals.

The main restriction for global contrast enhancement methods is that typical images often contain local bright and/or dark areas that are close to the boundaries of the dynamic range. Therefore, global contrast enhancement is often applied at low to moderate gains to prevent clipping or include some form of soft-clipping which however also reduces the effectiveness near the boundaries of the dynamic range. This shortcoming can be alleviated by enhancing the image contrast in a spatially localized and adaptive manner. Local contrast enhancement techniques aim at enhancing the visibility of local details by amplifying the difference between the luminance value of a pixel and its local mean.

An approach for local contrast enhancement is to boost higher spatial frequencies. A disadvantage of this and similar methods is that they tend to introduce halo artifacts around high-contrast edges and thus lead to suboptimal images.

It has been proposed to reduce halo artifacts by using non-linear edge-preserving low-pass filters or by adopting a multi-scale approach. However, such methods tend to often introduce clipping artifacts and often do not result in a full removal of halo artifacts. Furthermore, the approaches tend to suffer from degradation due to over-enhancements of flat areas resulting in an increased noise for such areas.

Hence, an improved contrast enhancement would be advantageous and in particular an approach allowing increased flexibility, improved enhancement quality, improved image quality, facilitated implementation, reduced complexity and/or improved performance would be advantageous.

### SUMMARY OF THE INVENTION

Accordingly, the Invention seeks to preferably mitigate, alleviate or eliminate one or more of the above mentioned disadvantages singly or in any combination.

According to an aspect of the invention there is provided a method of generating an enhanced image, the method comprising the steps of: receiving an image; generating a set of sub images from the image, different sub images of the set of sub images corresponding to different spatial frequency bands for the image; and for at least a first pixel region of the image: determining an pixel value variation measure in a neighborhood region of the first pixel region, and generating an enhanced pixel region for the enhanced image by combining the first pixel region and corresponding pixel regions of sub images in response to the pixel value variation measure.

The invention may provide improved and/or facilitated enhancement of images. Specifically, improved contrast enhancement of an image may be achieved in many scenarios and for many images. In particular, contrast enhancement may in many scenarios be achieved with reduced introduction of artifacts, such as halo effects and/or noise in flat areas.

An enhancement algorithm that adapts to the specific characteristics of the image can be achieved with low complexity and low resource requirements thus reducing memory and computational resource usage and/or allowing faster operation.

The pixel value variation measure may specifically be a pixel energy variation measure such as a luminance variation measure. Each pixel may be associated with one or more pixel values representing visual characteristics. The pixel value variation measure may be determined in response to one or more of such pixel values. Specifically, the pixel value variation measure may be determined to be indicative of a variation of one pixel value out of a set of pixel values. Alternatively, the pixel value variation measure may be determined to be indicative of a variation of a plurality of pixel values out of a set of pixel values. The pixel value variation measure may specifically be determined in response to a parameter being a function of a plurality of pixel values out of a set of pixel values. The set of pixel values for a pixel may characterize the visual characteristics of the pixel. For example, the visual characteristic of a pixel may be represented by RGB values (i.e. one value for a Red color component, one value for a Green color component, and one value for a Blue color component). In this case, the pixel value variation measure may e.g. be determined to represent a variation in the R value, the G value or the B value. However, as another example, a function may be applied to the RGB values to determine the energy (or amplitude) value for the pixel. For example, the squared sum of the RGB values may be determined and the pixel value variation measure may be determined in response to this value (which is indicative of the luminosity of the pixel). In other scenarios, each pixel may e.g. be represented in a YUV color space, i.e. by one luma (Y) and two chrominance (UV) values. In this case, the pixel value variation measure may e.g. be determined to reflect the variation of only the luminance Y value.

The neighborhood region may comprise an image area for which a distance criterion relative to the pixel region is met. For example, pixels having a distance of less than a threshold value may be considered to belong to the neighborhood region.

The set of sub images may comprise sub images corresponding to different but possibly overlapping spatial frequency bands. In some embodiments, sub images may be generated by applying different spatial frequency filtering to the image. Specifically, a given sub image may be generated by filtering the image with a first spatial low pass filter and subtracting a sub image generated using a second spatial low pass filter having a lower cut-off frequency that the first spatial low pass filter. In some embodiments, the image may be divided into the set of sub images. The sub images may be disjoint sub images. In some embodiments the sum of the sub images is equal to the image.

The combining may for example be by a weighted summation of the sub images. In some embodiments, some or all of the sub images may be individually processed as part of the combination. For example, a non-linear transfer function may be applied to the luminance of pixels of the corresponding pixel region of one or more sub images prior to these being combined/summed.

In accordance with an optional feature of the invention, the step of generating the enhanced pixel region comprises: determining a set of enhancement parameters in response to the pixel value variation measure, the set of enhancement parameters comprising an enhancement parameter for each sub image of the set of sub images, generating a modified pixel region for each sub image by applying the enhancement parameter for the sub image to a pixel region in the sub image corresponding to the first pixel region, and generating the enhanced pixel region by combining the first pixel region and the modified pixel regions.

This may provide a particularly advantageous image enhancement and may in particular provide a practical and flexible approach for adapting the image enhancement process to the specific characteristics of the image.

The enhancement parameter for a first sub image may specifically (at least partly) control an operation applied to the pixel luminosity of the sub image. For example, the enhancement parameter may specify a luminosity transfer function or a gain for the luminosity of the image. The enhancement parameter for a sub image may specifically be a gain/weight applied to the sub image as part of the combination.

In accordance with an optional feature of the invention, the step of generating the enhanced pixel region comprises generating the enhanced pixel region by a weighted combination of the first pixel region and the corresponding pixel regions with weights of the weighted combination being determined in response to the pixel value variation measure.

This may provide a particularly advantageous image enhancement and may in particular provide a practical and flexible approach for adapting the image enhancement process to the specific characteristics of the image.

In accordance with an optional feature of the invention, a weighting of a higher frequency sub image relative to a lower frequency sub image is increased for a higher pixel value variation measure relative to a weighting of the higher frequency sub image relative to the lower frequency sub image for a lower pixel value variation measure.

This may provide an improve contrast enhancement of an image and may in particular mitigate or reduce the artifacts introduced by the enhancement operation. Specifically, the approach may provide an easy to implement system that automatically adapts the contrast enhancement operation to the local image characteristics. In particular, the approach may result in increased contrast enhancement in areas with high degrees of detail and images while reducing the contrast enhancement (and thus noise) for flat image areas.

In accordance with an optional feature of the invention, the step of generating the enhanced pixel region comprises increasing a bias of at least one higher frequency sub image for a higher pixel value variation measure relative to a lower pixel value variation measure.

This may provide an improve contrast enhancement of an image and may in particular mitigate or reduce the artifacts introduced by the enhancement operation. Specifically, the approach may provide an easy to implement system that automatically adapts the contrast enhancement operation to the local image characteristics. In particular, the approach may result in increase contrast enhancement in areas with high degrees of detail and images while reducing the contrast enhancement (and thus noise) for flat image areas.

In accordance with an optional feature of the invention, the neighborhood region comprises only pixels with a distance of less than 50 pixels to the first pixel region.

This may provide improved performance in many scenarios and may in particular allow an efficient adaptation to local characteristics of the image. In many scenarios particularly advantageous performance is achieved when the neighborhood region comprises only pixels with a distance of less than 20 pixels to the first pixel region.

In accordance with an optional feature of the invention, the step of determining the pixel value variation measure comprises sub sampling the neighborhood region prior to determining the pixel value variation measure.

This may in many embodiments facilitate the enhancement operation and may provide high quality of the enhanced image while reducing complexity and resource requirements. In particular, the computational resource requirement may be substantially reduced.

In accordance with an optional feature of the invention, the method further comprises: providing a set of combination parameters for each class of a set of energy variation classes; selecting a first energy variation class from a set of energy variation classes for the pixel region in response to the pixel value variation measure; retrieving a first set of combination parameters corresponding to the first energy variation class; and wherein the combining is in response to the first set of combination parameters.

This may facilitate operation in many scenarios and may in particular reduce computational resource and data storage requirements. In many embodiments, the approach may facilitate the design and required determination of suitable parameters.

The combination parameters may specifically be enhancement parameters and/or weights (or gains) for the sub images.

In accordance with an optional feature of the invention, the step of determining the pixel value variation measure comprises: providing a set of pixel energy intervals; dividing pixels of the neighborhood region into the set of pixel energy intervals; and determining the pixel value variation measure in response to a number of pixels in at least one of the set of pixel energy intervals.

This may provide a particularly efficient implementation while still allowing high quality of the enhanced image. The pixel value variation measure may specifically be determined as or from the number of pixels in the N pixel energy intervals having the highest number of pixels. In many embodiments, N may advantageously be one, i.e. the pixel value variation measure may be determined as or from the number of pixels in the pixel energy interval having the highest number of pixels. In some embodiments, the number N may be determined in response to the distribution of pixels in the pixel energy intervals. For example, the number N may correspond to the number of pixel energy intervals that contain more than a given proportion of the total number of pixels (e.g. 30%).

In accordance with an optional feature of the invention, the pixel value variation measure is determined as a function of a proportion of pixels in a number of intervals comprising most pixels.

This may provide a particularly efficient implementation while still allowing high quality of the enhanced image. The pixel value variation measure may specifically be determined as or from the proportion of pixels in the N pixel energy intervals having the highest number of pixels. In many embodiments, N may advantageously be one, i.e. the pixel value variation measure may be determined as or from the proportion of pixels in the pixel energy interval having the highest number of pixels. In some embodiments, the number N may be determined in response to the distribution of pixels in the pixel energy intervals. For example, the number N may correspond to the number of pixel energy intervals that contain more than a given proportion of the total number of pixels (e.g. 30%).

In accordance with an optional feature of the invention, determining the pixel value variation measure comprises determining the pixel value variation measure in response to pixel energies for pixels of the neighborhood region.

This may provide improved image enhancement in many embodiments.

In accordance with an optional feature of the invention, the method further comprises attenuating spatial frequencies below a first frequency prior to determining the pixel value variation measure.

This may provide improved image enhancement in many embodiments. In particular, the approach may provide improved performance for images containing energy gradients.

In some embodiments the pixel value variation measure may be determined in response to pixel energies of the image following spatial high pass filtering.

In some embodiments determining the pixel value variation measure may comprise determining the pixel value variation measure in response to pixel energies in a spatial frequency band not including spatial frequencies below a threshold frequency.

In some embodiments determining the pixel value variation measure may comprise determining the pixel value variation measure in response to pixel energies of at least one of the sub images (and specifically in response to a combination of a set of sub images excluding the sub image comprising the lowest spatial frequency).

In some embodiments determining the pixel value variation measure may comprise determining the pixel value variation measure in response to pixel energies of an image generated by subtracting a sub image having the lowest spatial frequencies of the set of sub images from the image.

In accordance with an optional feature of the invention, the method further comprises the step of generating a noise estimate for the image and wherein the combining is further in response to the noise estimate.

This may further improve the enhancement of the image and may allow an efficient and low complexity approach for considering multiple characteristics when adapting the image enhancement operation. In particular, the feature may allow reduced noise artifacts to be introduced as part of the (contrast) enhancement operation.

According to an aspect of the invention there is provided a computer program product for executing the above described method.

According to an aspect of the invention there is provided an apparatus for generating an enhanced image, the apparatus comprising: means for receiving an image; means for generating a set of sub images from the image, different sub images of the set of sub images corresponding to different spatial frequency bands for the image; and means for, for at least a first pixel region of the image, performing the steps of: determining an pixel value variation measure in a neighborhood region of the first pixel region, and generating an enhanced pixel region for the enhanced image by combining the first pixel region and corresponding pixel regions of sub images in response to the pixel value variation measure.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates an example of a method of generating an enhanced image in accordance with some embodiments of the invention;

FIG. 2 illustrates an example of an apparatus of generating an enhanced image in accordance with some embodiments of the invention;

FIG. 3 illustrates an example of steps of a method of generating an enhanced image in accordance with some embodiments of the invention; and

FIG. 4 shows an example of an image comprising a luminance gradient.

### DETAILED DESCRIPTION OF THE EMBODIMENTS

The following description focuses on embodiments of the invention applicable to contrast enhancement of digital images that are frames of a video signal. However, it will be appreciated that the invention is not limited to this application.

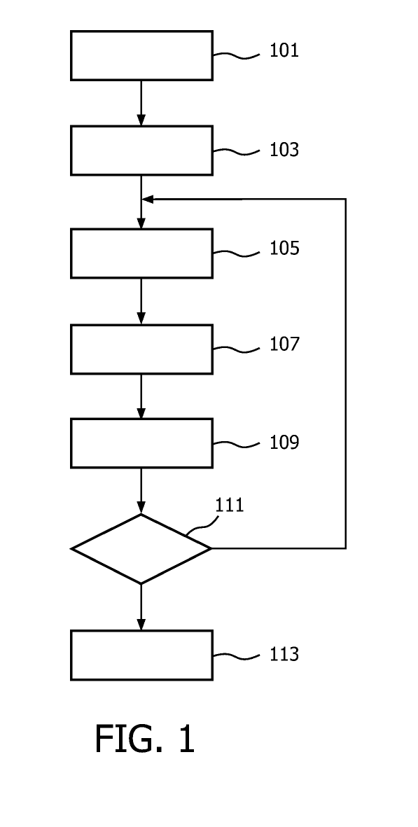

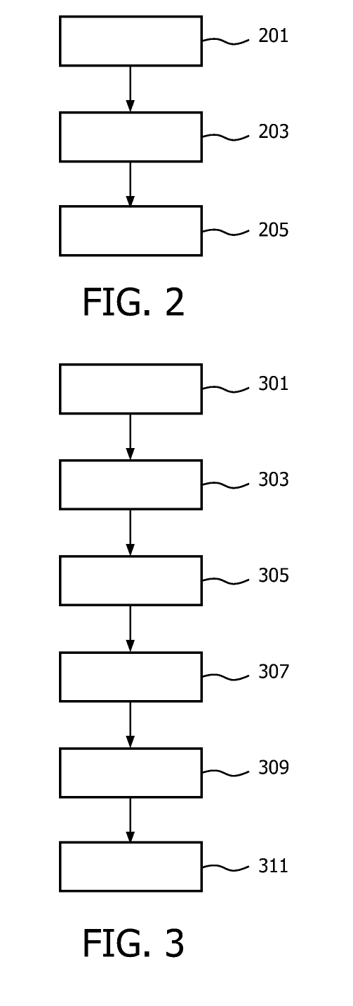

FIG. 1 illustrates an example of a method of generating an enhanced image. The method may specifically be performed by the apparatus illustrated in FIG. 2 and will be described with reference thereto.

The method initiates in step 101 wherein the image receiver 201 receives an image to be enhanced. In the specific example, the image receiver 201 receives a video signal and proceeds to decode the video signal to generate individual video frames/images that are enhanced individually.

The image receiver 201 is coupled to a sub image processor 203 which is fed the image to be enhanced. The sub image processor 203 proceeds to execute step 203 wherein a set of sub images is generated from the received image. The sub image processor 203 generates the set of sub images such that the different sub images comprise different spatial frequency bands for the image. For example, each sub image may be generated by applying a filtering operation to the image. E.g. a first sub image may be generated by spatially low pass filtering the image, a second sub image may be generated by spatially high pass filtering the image and the remaining sub images may be generated by band pass filtering the image.

The band of a sub image may e.g. be considered to be the frequency band in which the spatial frequencies of the sub image are attenuated by less than a given threshold relative to the image (apart from possibly a scale factor which is constant for all frequencies). The frequency bands for different sub images are different but may possibly be overlapping to some extent.

Thus, the sub image processor generates a set of sub images which represent different spatial frequency intervals/bands of the image. E.g. one sub image may represent low frequencies, another may represent high frequencies and a number of sub images may represent intermediate spatial frequency bands.

The sub image processor 203 is coupled to an enhancement processor 205. The enhancement processor 205 receives the sub images and the original image from the sub image processor 203 and proceeds to generate an enhanced image. The enhanced image is generated by iteratively and sequentially processing and enhancing different pixel regions of the image.

Specifically, the enhancement processor 205 first executes step 105 wherein a pixel region is selected. In many embodiments, each pixel region consists in only a single pixel but it will be appreciated that in other embodiments, a pixel region comprising a plurality of pixels may be processed in each iteration.

Following step 105, the enhancement processor 205 executes step 107 wherein a pixel value variation measure for the image in a neighborhood region of the first pixel region is generated.

Thus, for the pixel region (and in many embodiments for the pixel) currently being processed, the enhancement processor 205 first determines a neighborhood region. The neighborhood region is typically an image area comprising pixels that meet a given distance criterion relative to the pixel region being processed. For example, the neighborhood region may comprise some or all pixels for which the distance to the pixel region being processed is less than a given predetermined value but not any pixels at a further distance. In many embodiments it has been found particularly advantageous to determine a neighborhood region to exclude all pixels having a distance to the pixel region of more than 50 pixels (e.g. measured as pixel widths, heights and/or diagonals). Particularly advantageous performance has been found for a neighborhood region excluding all pixels having a distance to the pixel region of more than 20 pixels.

The pixel value variation measure is indicative of the variation of one or more pixel values within the neighborhood region. Each pixel value may provide a (partial) representation of a visual characteristic of the pixel. In particular, the pixel value variation measure may be indicative of the variation of the pixel energy within the neighborhood region. In particular, the pixel value variation measure may be a luminance variation measure indicative of the variation of the pixel luminance within the neighborhood region. It will be appreciated that in different embodiments, different types of pixel value variation measures may be determined. As a specific example, the pixel value variation measure may be determined as the luminance variance within the neighborhood region.

Step 107 is followed by step 109 wherein an enhanced pixel region is generated by combining the corresponding pixel regions of the image and the sub images. The combination is adapted in response to the pixel value variation measure.

Specifically, a selective combination of the original image with the sub images may allow different spatial frequency bands and thus characteristics to be modified thereby leading to a perceived enhanced image. Specifically, by introducing a bias to the higher frequencies, an enhanced contrast image pixel region may be generated. Conversely, by reducing the bias of higher frequencies and possibly biasing lower frequencies, reduced noise may be produced in flat image areas.

The combination of the sub images and the image for the pixel region is varied in dependence on the pixel value variation measure. Specifically, for a pixel value variation measure indicative of a high energy variation in the neighborhood region, it is likely that the pixel region is part of a high detail area with a high probability of sharp edges. Accordingly, the sub images corresponding to high frequencies are strongly biased to provide contrast enhancement. However, for a pixel value variation measure indicative of a low energy variation in the neighborhood region, it is likely that the pixel region is part of a flat detail area with a very low probability of sharp edges. Accordingly, the sub images corresponding to low frequencies are strongly biased relative to the higher frequency sub images thereby reducing the introduced noise.

In the specific example, the combination may be achieved by a weighted combination and specifically by a weighted summation of the pixel region of the original image and the corresponding (i.e. located at the same position in the image) pixel regions of the sub images. In this example the weights of the weighted combination are determined based on the pixel value variation measure. Specifically, the weight or gain for the pixel(s) of the pixel region for a given sub image is determined from the pixel value variation measure. For example, for a high variation value of the pixel value variation measure, the weight for the higher frequency sub images is set relatively high and the weight for the lower frequency sub images is set relatively low. In contrast, for a low variation value of the pixel value variation measure, the weight for the higher frequency sub images is set relatively low and the weight for the lower frequency sub images is set relatively high.

Thus, in the example, the weighting of a higher frequency sub image (relative to a lower frequency sub image) is higher for at least one higher pixel value variation measure than a weighting of the higher frequency sub image (relative to the lower frequency sub image) for at least one lower pixel value variation measure. Thus, the relative biasing of at least two of the sub images depends on the pixel value variation measures such that the sub image that contains a frequency band with spatial frequencies (at least on average) higher than the other sub image is biased higher for at least one value of the pixel value variation measure than it is for at least one lower value of the pixel value variation measure. It is noted that it is not essential in such an example which of the sub images is considered to be the higher frequency sub image and which is the lower frequency sub image but just that two sub images exist that have such a relationship (namely that one sub image contains (on average) higher frequencies than the other) and that the biasing of these two is modified such that the biasing for the higher frequency band is higher for at least a first pixel value variation measure value than for at least a second pixel value variation measure value where the first pixel value variation measure value is indicative of a higher variation than second pixel value variation measure.

Following step 109, the enhancement processor 205 proceeds to execute step 111 wherein it is determined whether more pixel regions should be processed. In the specific example, the process is applied to the whole image and thus step 111 evaluates whether there are any pixels left in the image that have not previously been processed (i.e. that have not previously been included in a pixel region). If so, the method returns to step 105 wherein the next pixel region is selected and otherwise the method proceeds to step 113 where the method stops (or e.g. in the case of a video signal the method may return to step 101 to process the next frame of the video signal).

The described approach may provide an improved image enhancement. In particular, it may provide an efficient contrast enhancement for an image while at the same time maintaining low noise for flat image areas. Indeed, strong contrast enhancement may be automatically focused on areas which are likely to be high in detail and possibly containing many edges without the contrast enhancement resulting in substantially increased noise for flat(ter) areas. The control of the contrast enhancement is achieved by combining sub images of different spatial frequency bandwidths based on an pixel value variation measure allows particularly efficient adaptation of the contrast enhancement while at the same time allowing a practical implementation that does not require excessive computational resources. In particular, faster locally adaptive contrast enhancement can be achieved which in many cases may even allow real time contrast enhancement for video signals. Furthermore, the use of a pixel value variation measure for locally adapting the significance of individual spatial frequency bands provides a particularly high image quality and efficient implementation.

It will also be appreciated that the approach may allow different forms of image enhancement and specifically contrast enhancement can be achieved by biasing higher frequency sub bands whereas enhancement (reduction) of noise can be achieved by biasing lower frequency sub bands. It will also be appreciated that the term “enhancement” does not imply that the resulting image is necessarily improved. Indeed, it is well appreciated in the field that applying an enhancement algorithm to an image may in some cases result in an improvement, in other cases may result in a degradation, and e.g. may result in an improvement of some parameters at the expense of a degradation of others depending on the characteristics of the image. For example, although a contrast enhancement algorithm seeks to increase the perceived contrast of an image, the application of the algorithm to some images may result in degradation of some characteristics such as the introduction of artifacts. Indeed, for some images, the image content may even be such that the contrast enhancement reduces the perceived contrast (e.g. a gamma contrast enhancement algorithm may reduce the contrast for edges between two light (or dark) image areas with relatively similar luminosity). Thus, the term “enhance” may be considered equivalent to “modify” or “process”.

In the following, a specific example of the operation of the enhancement processor 205 will be described. In particular, the following description will provide more detail on possible implementations of some of the steps of the method of FIG. 1.

In the detailed example, the generation of sub images in step 103 is performed by filtering the input image using different spatial low-pass filters. Specifically, the sub image processor 203 may apply a multi-scale approach by first applying sequential low-pass filters according to:

Vᵢ^{LP}=Fᵢ^{LP} [symbol] V

where V represents the luminance values of the input image, Fᵢ^{LP} represents the spatial filter kernel of the low-pass filter for scale i and Vᵢ^{LP} denotes the low-pass filtered output for scale i.

The sub images can then be generated from these low-pass images by subtracting the sub image of for the next lower scale sub image:

Bᵢ=Vᵢ^{LP}−Lᵢ₋₁^{LP}

Thus, in the specific example, the sub images have disjoint frequency bands and together add up to the input image.

The determination of the pixel value variation measure and the combination performed in steps 107 and 109 of FIG. 1 will for the specific example be described with reference to FIG. 3.

In this example, the luminances of the pixels in the neighborhood region are divided into a number N of discrete bins and the pixel value variation measure is determined on the basis of the distribution of the pixels in the bins.

Specifically, the enhancement processor 205 executes step 301 wherein a number of pixel energy intervals (henceforth referred to as “bins”) are provided. In the specific example a predetermined number of fixed intervals or bins are provided. Specifically, the luminance for each pixel may be represented by a value between 0 to 255. In the example, a total of 32 uniform bins are used resulting in each bin comprising 8 values. Thus, one bin corresponds to the luminance value interval [0;7], the next to the luminance value interval [8;15] etc.

The enhancement processor 205 then proceeds to divide the pixels of the neighborhood region into the bins. Specifically, for each pixel in the neighborhood region, the luminance is retrieved and it is determined which of the 32 bins this value belongs to. The accumulated value (pixel count) of this bin is then incremented. Thus, a histogram of the pixel luminance values for the neighborhood region may be calculated, e.g. as:

H(k)=Σsεw[w·k . . . w·(k+1)−1]

where k is the bin-number (in the present case 0-31), the interval width is w (in the present case 8) and s denotes the luminance value (in the interval [0;255]) and the summation is extended over the neighborhood region.

In the example, the pixel value variation measure is then determined dependent on the distribution of the pixels of the neighborhood region in the bins. Thus, the pixel value variation measure is determined from the number of pixels in at least one of the set of pixel energy intervals.

In the specific example, the pixel value variation measure is determined in response to a proportion of pixels that are in a number of bins that contain the most pixels. Specifically, the pixel value variation measure is determined to correspond to the proportion of pixels in the bin with the highest number of pixels. Thus, the enhancement processor 205 proceeds to execute step 303 wherein the bin with the most pixels is determined. The pixel count for the most populated bin is represented by:

Hₘₐₓ=max(H(k))

the pixel value variation measure may then be determined as the ratio of this to the total number of pixels in the neighborhood region:

$${E}_{Var} = \frac{{H}_{Max}}{L}$$

where L is the total number of pixels in the neighborhood region.

It will be appreciated that in other embodiments, other measures may be used. Also, in other embodiments, the pixel count for a plurality of bins may be considered. The number of bins may be predetermined or may e.g. be determined based on the pixel characteristics in the neighborhood region.

In many embodiments, a neighborhood region may be defined e.g. to not include any pixels that are more than 50 pixels, or in many embodiments advantageously 20 pixels, from the current pixel. It has been found that this in many embodiments provide a highly advantageous trade-off between computational resource usage, reliability of the adaptation and the degree of localized adaptation of the enhancement process.

In some embodiments, the neighborhood region may be subsampled prior to the determination of the pixel value variation measure. Thus, the determination of the pixel value variation measure may be based on subsampled energy values for the neighborhood region. For example, only every other pixel may be considered when generating the histogram.

In the specific example, the adaptation of the processing for the pixel region is based on a discrete pixel value variation measure that may take on only a limited number of values. This may facilitate operation and may in particular facilitate the determination and storage of adaptation parameters for the enhancement operation.

Specifically, in the example, the enhancement processor 205 proceeds in step 305 to determine an energy variation class for the pixel region from a set of set of energy variation classes. Thus, a limited set of energy variation classes are defined and the enhancement processor 205 evaluates the pixel value variation measure generated in step 303 to select one of the energy variation classes.

As a specific example, five energy variation classes may be defined with each class corresponding to an interval of the pixel value variation measure. Thus, four thresholds may be defined for the proportion of pixels in the most populated bin E_{Var}. The thresholds are specifically set as a percentage of the total number of pixels in the window, such as e.g.:
E_{Var}≧90%: Class 1
75%<E_{Var}≦90%: Class 2
55%<E_{Var}≦75%: Class 3
30%<E_{Var}≦55%: Class 4
E_{Var}≦30%: Class 5

Thus, based on the local luminance variations in a neighborhood region, the pixel region (and the pixel value variation measure) is determined to belong to one of five discrete classes. Each class represents a (presumed) degree of variation and likelihood of edges in the local area around the pixel region. Specifically, if most luminance values are concentrated in a single bin, it is likely that the pixel region belongs to a flat and homogenous image area. Thus, class 1 corresponds to a high likelihood that the pixel is in a flat image area where contrast enhancement should not be applied as this is likely to merely increase noise. Conversely if the pixel luminance values are more equally distributed across the bins, and thus a lower proportion is in the most populated pixel, it is more likely that the pixel belongs to a more detailed image area with higher likelihood of edges. Thus, class 5 represents a higher likelihood that the pixel region belongs to a high detail area wherein aggressive contrast enhancement can advantageously be applied.

Thus, in step 305, the enhancement processor 205 proceeds to determine an energy variation class for the pixel (region) currently being processed. The enhancement processor 205 then proceeds in step 307 wherein a set of combination/enhancement parameters that correspond to the determined energy variation class are determined.

Specifically, the enhancement processor 205 may store a set of combination/enhancement parameters that is to be used when combining the sub images for each possible class. The combination/enhancement parameters may specifically correspond to a weight for each sub image that should be applied when combining the current pixel (region) of the input image with the corresponding pixel (regions) of the sub images.

The combination/enhancement parameters (e.g. the weights) may be predetermined values that have been determined offline for each energy variation class. Thus, by using a discrete representation of the pixel value variation measure (i.e. through the energy variation classes), the determination and storage of suitable combination/enhancement parameters may be substantially facilitated.

In the specific example, the enhancement processor 205 assigns individual gains or weights to each sub image based on the energy variation classification. E.g. if the pixel falls into class 1 (flat area), higher frequencies are suppressed and if it falls into class 5 they are enhanced. The weights/gains are selected such that for other classes, intermediate weights are applied. Thus, in the specific example a total of four sub images are used resulting in only 20 weights needing to be stored.

Step 307 is followed by step 309 wherein the pixel (region) of each sub image at the same location as the pixel (region) being processed is weighted by the weight retrieved for the current class. Thus, the retrieved combination/enhancement parameter for each sub image is applied to the corresponding pixel (region) of the sub image.

It will be appreciated that although the combination/enhancement parameter in the specific example corresponds to a simple weight or gain, other and typically more complex parameters may be used in other embodiments. For example, rather than a simple weight, a combination/enhancement parameter may define a transfer function characterizing how a modified pixel value should be calculated from the sub image pixel value.

Step 309 is followed by step 311 wherein the resulting pixel values of the sub images are combined with the pixel value of the pixel in the input image to generate an enhanced pixel value for the resulting enhanced output image.

The combination may include non-linear combinations or consideration of other characteristics or parameters but in the specific example the combination simply corresponds to a summation of the pixel value from the original image and the modified pixel values from the sub images. Thus, the combined effect of the generation of the modified sub image pixels and the summation corresponds to a weighted summation of the pixel of the input image and the corresponding pixels of the sub images with weights determined in response to the pixel value variation measure. Specifically, the enhanced pixel value O of the enhanced output image may be determined as:

$$O = V + {\sum }_{i} {B}_{i} {G}_{i}$$

where Gᵢ is the gain/weight for sub image i, Bᵢ is the corresponding pixel value for sub image i, and V is the pixel value of the original input image.

In the example, the bias of higher frequency sub images is increased for a higher pixel value variation measure relative to a lower pixel value variation measure. Specifically, the ratio between the weight for the highest frequency sub image and the weight for at least one of the other sub images is higher for a higher pixel value variation measure than for a lower pixel value variation measure. Specifically, the ratio is higher for class 5 than for class 4 which again is higher than for class 3 etc. Similarly, the weight/gain for the highest frequency sub image is higher for a higher pixel value variation measure than for a lower pixel value variation measure. Thus, the weight/gain for the highest frequency sub image is higher for class 5 than for class 4 which again is higher than for class 3 etc. In contrast, the weight/gain for the lowest frequency sub image is higher for a lower pixel value variation measure than for a higher pixel value variation measure. Thus, the weight/gain for the lowest frequency sub image is higher for class 1 than for class 2 which again is higher than for class 3 etc.

Thus, dynamic and flexible weighting and combination of different sub images corresponding to different spatial frequency bands provides an improved enhancement for many images. Specifically, the increased bias of higher frequencies in high detail areas provides for an increased contrast whereas the increased relative bias of lower frequencies in low detail (flat) areas provides for a reduced noise. Thus, an improved image may be generated. Furthermore, the approach allows easy implementation and a low computational resource usage.

In some embodiments, the determination of the pixel value variation measure may include a preprocessing of the pixel values of the original image. Specifically, the image may be pre-processed such that spatial frequencies below a first frequency are attenuated prior to the pixels of the neighborhood region being evaluated to determine the pixel value variation measure. For example, a spatial high pass filtering may be performed to remove/attenuate very low spatial frequencies. In some embodiments, the attenuation of the low frequencies may be based on the filtering used to generate the sub images and may even be achieved by determining the pixel value variation measure by evaluating pixel values of one of the sub images.

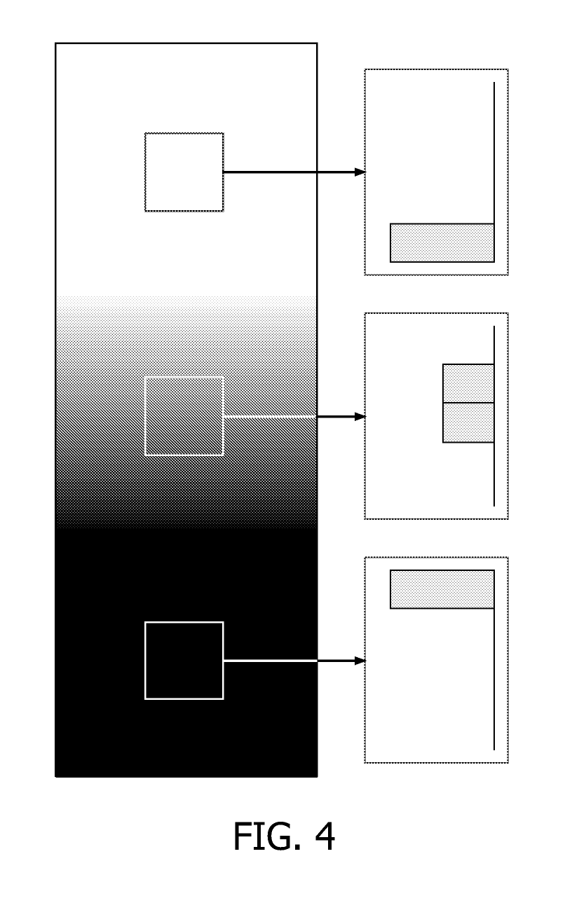

The attenuation of lower frequencies may specifically be useful for image areas that include gradients. Specifically, the described example generates a histogram from the pixel values in the neighborhood region. However, as a histogram is a discrete function, it is often advantageous to take into account the effect of the classification of gradients. For example, FIG. 4 illustrates an example with a very gradual luminance transition. This should still be treated as a flat area as no sharp edge is present that should be emphasized by an increased contrast. However, due to the discrete nature of the histogram, the pixels of even a small neighborhood region in areas corresponding to luminance values around the bin transitions will fall into two bins resulting in a substantially reduced proportion of pixels in the most populated bin. Indeed, in the specific example, this will result in a classification into class 4 rather than the more appropriate class 1.

In the specific example, this issue may be addressed by determining the pixel value variation measure in response to pixel energies of an image generated by subtracting the sub image having the lowest spatial frequencies of the set of sub images from the input image. Thus, the enhancement processor 205 may for all images of the input image perform the operation:

B′₁=V−V₁^{LP}

where V is the luminance of the original input image pixel and V₁^{LP} denotes the low-pass filtered image for the first sub image. Thus, assuming that slow gradients remain in the image after the low-pass filtering, this operation will remove the gradients of the original image from the new image B′ᵢ. The pixel value variation measure may then be determined by evaluating of the pixel values of B′ᵢ in the neighborhood region.

In some embodiments, the process may further include the generation of a noise estimate for the input image. It will be appreciated that many algorithms for determining an image noise estimate are known and may be used without detracting from the invention. The combining of the sub images may take this noise estimate into control. For example, the enhancement processor 205 may dynamically adapt the thresholds for the different energy variation classes depending on the noise estimate. For instance, in the presence of substantial noise, the threshold for class 1 can be reduced to reduce the probability that noise will be confused with the presence of a high degree of image detail.

It will be appreciated that different approaches can be used for determining suitable combination/enhancement parameters.

For example, a subjective evaluation method may be used to find suitable weights for the different sub images and energy variation classes. E.g. a subjective evaluation on a statistically relevant target may be used to determine weights for each subband for each class. Thus, in the specific example, a total of 20 parameters should be determined. In order to facilitate this process, the evaluators may e.g. only change the weight for the class that represents the highest detail (class 5). The class with the lowest detail (class 1) may then be set to be a fixed low value and for intermediate classes, the weights may be determined by interpolation (e.g. by a linear interpolation). This may reduce the number of parameters to be defined to the number of sub images.

As another example, an analytical approach may be used to determine weights so that the results are similar to a known contrast enhancement. Specifically, a series of images can be enhanced with a desired target contrast enhancement algorithm and e.g. a Least Mean Square optimization process can be performed to select weights that minimize the differences between these results and those generated by the current algorithm.

Specifically, the following mathematical model may be used.

The output of the current contrast enhancement method for a given class may be given by:

$$O = V + {\sum }_{i} {B}_{i} {G}_{i}$$

For a given image enhanced by a target algorithm and denoted O_{GT}, the Minimum Square Error of a class can be represented by

$$\begin{matrix}M S E = {\sum }_{k = 1}^{{N}_{T}} {( {O}_{GT} - O )}^{2} \\ = {\sum }_{k = 1}^{{N}_{T}} ( {O}_{GT}^{2} - 2 {O}_{GT} ( V + {\sum }_{i} ( {B}_{i} \cdot {G}_{i} ) ) + {( V + {\sum }_{i} ( {B}_{i} \cdot {G}_{i} ) )}^{2} )\end{matrix}$$

where N_{T} is the number of pixels gathered during training for this particular class.

To find the minimum of the MSE, the derivative of the previous equation must be equal to zero.

$$\begin{matrix}\frac{\partial M S E}{\partial {G}_{j}} = {\sum }_{k = 1}^{{N}_{T}} ( - {20}_{GT} \cdot {B}_{j} + 2 ( V + {\sum }_{i} ( {B}_{i} \cdot {G}_{i} ) ) {B}_{j} ) \\ = {\sum }_{k = 1}^{{N}_{T}} ( - 2 {O}_{GT} \cdot {B}_{j} + 2 V \cdot {B}_{j} + 2 {\sum }_{i} ( {B}_{i} \cdot {G}_{i} ) ) \\ = 0\end{matrix}$$

with 0≦j<N, where N is the number of sub images.

By solving this equation the optimal gains can be calculated:

$$G = {X}^{- 1} Y$$

$$where$$

$$G = {[ \begin{matrix}{G}_{0} & {G}_{1} & … & {G}_{N - 1}\end{matrix} ]}^{T}$$

$$X = [ \begin{matrix}{\sum }_{k = 1}^{{N}_{T}} ( {B}_{0} \cdot {B}_{0} ) & {\sum }_{k = 1}^{{N}_{T}} ( {B}_{0} \cdot {B}_{1} ) & … & {\sum }_{k = 1}^{{N}_{T}} ( {B}_{0} \cdot {B}_{N - 1} ) \\ {\sum }_{k = 1}^{{N}_{T}} ( {B}_{1} \cdot {B}_{0} ) & {\sum }_{k = 1}^{{N}_{T}} ( {B}_{1} \cdot {B}_{1} ) & … & {\sum }_{k = 1}^{{N}_{T}} ( {B}_{1} \cdot {B}_{N - 1} ) \\ ⋮ & ⋮ & ⋱ & ⋮ \\ {\sum }_{k = 1}^{{N}_{T}} ( {B}_{N - 1} \cdot {B}_{0} ) & {\sum }_{k = 1}^{{N}_{T}} ( {B}_{N - 1} \cdot {B}_{1} ) & … & {\sum }_{k = 1}^{{N}_{T}} ( {B}_{N - 1} \cdot {B}_{N - 1} )\end{matrix} ]$$

$$Y = {[ \begin{matrix}{\sum }_{k = 1}^{{N}_{T}} ( {O}_{GT} - V ) \cdot {B}_{0} & {\sum }_{k = 1}^{{N}_{T}} ( {O}_{GT} - V ) \cdot {B}_{1} & … & {\sum }_{k = 1}^{{N}_{T}} ( {O}_{GT} - V ) \cdot {B}_{N - 1}\end{matrix} ]}^{T}$$

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality. Reference signs in the claims are provided merely as a clarifying example shall not be construed as limiting the scope of the claims in any way.

1. A method of generating an enhanced image, the method comprising the steps of:
receiving (101) an image;
generating (103) a set of sub images from the image, different sub images of the set of sub images corresponding to different spatial frequency bands for the image; and
for at least a first pixel region of the image:
determining (107) an pixel value variation measure in a neighborhood region of the first pixel region, and
generating (109) an enhanced pixel region for the enhanced image by combining the first pixel region and corresponding pixel regions of sub images in response to the pixel value variation measure.

2. The method of claim 1 wherein the step of generating the enhanced pixel region comprises:
determining (301-307) a set of enhancement parameters in response to the pixel value variation measure, the set of enhancement parameters comprising an enhancement parameter for each sub image of the set of sub images,
generating (309) a modified pixel region for each sub image by applying the enhancement parameter for the sub image to a pixel region in the sub image corresponding to the first pixel region, and
generating (311) the enhanced pixel region by combining the first pixel region and the modified pixel regions.

3. The method of claim 1 wherein the step of generating (109) the enhanced pixel region comprises generating the enhanced pixel region by a weighted combination of the first pixel region and the corresponding pixel regions with weights of the weighted combination being determined in response to the pixel value variation measure.

4. The method of claim 3 wherein a weighting of a higher frequency sub image relative to a lower frequency sub image is increased for a higher pixel value variation measure relative to a weighting of the higher frequency sub image relative to the lower frequency sub image for a lower pixel value variation measure.

5. The method of claim 1 wherein the step of generating (109) the enhanced pixel region comprises increasing a bias of at least one higher frequency sub image for a higher pixel value variation measure relative to a lower pixel value variation measure.

6. The method of claim 1 wherein the neighborhood region comprises only pixels with a distance of less than 50 pixels to the first pixel region.

7. The method of claim 1 wherein the step of determining (107) the pixel value variation measure comprises sub sampling the neighborhood region prior to determining the pixel value variation measure.

8. The method of claim 1 further comprising:
providing a set of combination parameters for each class of a set of energy variation classes;
selecting (305) a first energy variation class from a set of energy variation classes for the pixel region in response to the pixel value variation measure;
retrieving (307) a first set of combination parameters corresponding to the first energy variation class; and
wherein the combining (309, 311) is in response to the first set of combination parameters.

9. The method of claim 1 wherein the step of determining (107) the pixel value variation measure comprises
providing (301) a set of pixel energy intervals;
dividing (301) pixels of the neighborhood region into the set of pixel energy intervals; and
determining (303) the pixel value variation measure in response to a number of pixels in at least one of the set of pixel energy intervals.

10. The method of claim 9 wherein the pixel value variation measure is determined as a function of a proportion of pixels in a number of intervals comprising most pixels.

11. The method of claim 1 wherein determining (107) the pixel value variation measure comprises determining the pixel value variation measure in response to pixel energies for pixels of the neighborhood region.

12. The method of claim 11 further comprising attenuating spatial frequencies below a first frequency prior to determining the pixel value variation measure.

13. The method of claim 1 further comprising the step of generating a noise estimate for the image and wherein the combining is further in response to the noise estimate.

14. A computer program product for executing the method of claim 1.

15. An apparatus for generating an enhanced image, the apparatus comprising:
means (201) for receiving an image;
means (203) for generating a set of sub images from the image, different sub images of the set of sub images corresponding to different spatial frequency bands for the image; and
means (205) for, for at least a first pixel region of the image, performing the steps of:
determining an pixel value variation measure in a neighborhood region of the first pixel region, and
generating an enhanced pixel region for the enhanced image by combining the first pixel region and corresponding pixel regions of sub images in response to the pixel value variation measure.
